(19) United States
(12) Patent Application Publication
(10) Pub. No.: US 2007/0104243 A1
(43) Pub. Date: May 10, 2007

(54) LASER APPARATUS FOR TREATING WORKPIECE

(75) Inventor: Ga-Lane Chen, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,606

(22) Filed: Aug. 30, 2006

(30) Foreign Application Priority Data
Nov. 10, 2005 (CN) 200510101185.6

(51) Int. Cl. H01S 3/08

(52) U.S. Cl. 372/101

(57) ABSTRACT

The present invention relates to a laser apparatus for treating a workpiece. The laser apparatus includes a worktable, a cooling device, a laser, and a lens assembly. The cooling device is disposed on the worktable, the workpiece is positioned on the cooling device, and the cooling device is configured for absorbing heat from the workpiece. The laser is configured for generating a laser beam. The lens assembly is configured for converging the laser beam onto the workpiece.

### CROSS-REFERENCE TO RELATED APPLICATIONS

This application is related to commonly-assigned co-pending applications entitled, “LASER WELDING SYSTEM FOR WELDING WORKPIECE”, filed on Jun. 23, 2006 (U.S. application Ser. No. 11/473,965), “LASER SYSTEM AND METHOD FOR PATTERNING MOLD INSERTS”, filed on Jul. 28, 2006 (U.S. application Ser. No. 11/309,343), and “APPARATUS FOR PROCESSING WORK-PIECE”, filed on Jul. 31, 2006 (U.S. application Ser. No. 11/309,353), and “LASER TREATMENT APPARATUS”, filed xxxx (Atty. Docket No. US8617). Disclosures of the above identified applications are incorporated herein by reference.

### TECHNICAL FIELD

The present invention relates generally to laser apparatuses, and more particularly, to a laser apparatus for treating a workpiece.

Since lasers were first introduced into welding technical field in 1970s, lasers have been found to be very versatile, having applications including surface treatment (including welding) of metals, metal alloys, glasses, ceramics, and even plastics. For example, laser welding, which joins two formerly separate workpieces, has been demonstrated capable of joining not only workpieces of similar material, but also workpieces of dissimilar materials.

Laser apparatuses, which utilizes a laser such as carbon dioxide (CO2) laser for generating a powerful laser beam. The CO2 laser beam has a wavelength about 10.6 microns, and has several important advantages, such as high efficiency of power output, and good laser beam stability. When, for example, being used for welding, the laser beam is focused on a joint between two workpieces, heat from the laser beam makes the joint area materials melt, thus forming a weld pool. The weld pool contains the melt materials, and may penetrate a certain distant depth into the workpieces. When the laser beam moves along the joint between the workpieces, the weld pool moves along therewith, and the melt materials contained in the weld pool are cooled down, thus the joint between the workpieces forms a welding seam.

However, during the welding process of the workpieces, the joint area may easily become local overheated due to the heat from the powerful laser beam, thus leading to the welding seam having a weak bonding strength, and an uneven welding surface.

What is needed, therefore, is a laser apparatus for treating a workpiece which overcomes the above-mentioned problems.

### SUMMARY

In a preferred embodiment, an exemplary laser apparatus for treating a workpiece includes a worktable, a cooling device, a laser, and a lens assembly. The cooling device is disposed on the worktable, the workpiece is positioned on the cooling device, and the cooling device is configured for absorbing heat from the workpiece. The laser is configured for generating a laser beam. The lens assembly is configured for converging the laser beam onto the workpiece.

Other objects, advantages and novel features of the invention will become more apparent from the following detailed description when taken in conjunction with the accompanying drawings.

### BRIEF DESCRIPTION OF THE DRAWINGS

Many aspects of the laser apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a schematic view of a laser apparatus according to a preferred embodiment;

FIG. 2 is a schematic view of a laser shown in FIG. 1;

FIG. 3 is a schematic view of a cooling device shown in FIG. 1; and

FIG. 4 is a schematic view of a cooling unit shown in FIG. 3.

### DETAILED DESCRIPTION OF THE PREFERRED EMBODIMENTS

Embodiments of the present laser apparatus for treating a workpiece will now be described in detail below and with reference to the drawings.

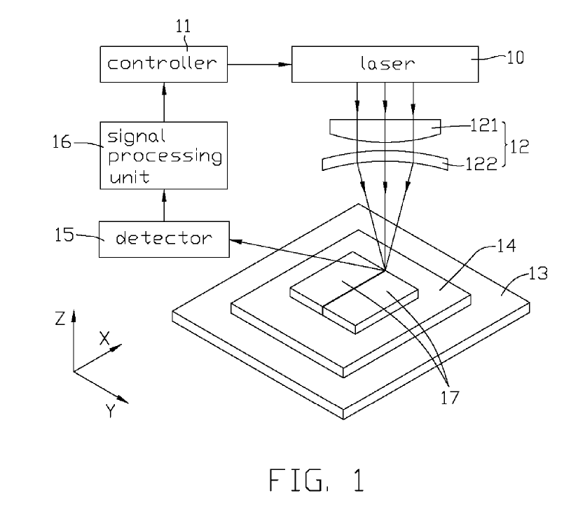

Referring to FIG. 1, an exemplary laser apparatus is used for welding two workpieces 17, the laser apparatus includes a laser 10, a controller 11, a lens assembly 12, a worktable 13 and a cooling device 14.

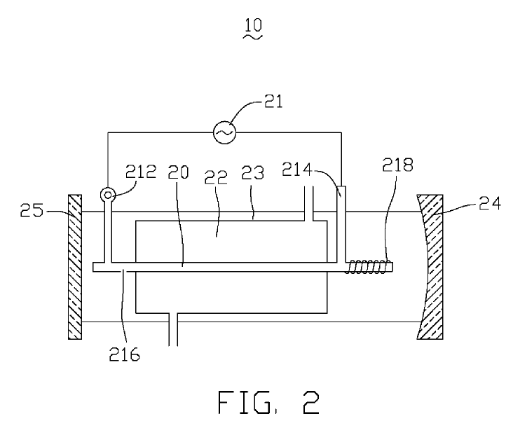

Referring also to FIG. 2, the laser 10 includes a discharge tube 20, a cooler 22, a gas chamber 23, a first mirror 24 and a second mirror 25. The discharge tube 20 includes a cathode 212 and an anode 214. The discharge tube 20 is held within the cooler 22. The discharge tube 20 and the cooler 22 are placed inside the gas chamber 23. The first mirror 24 and the second mirror 25 each are positioned at one end of the gas chamber 23 respectively to seal the gas chamber 23, thus form an oscillating chamber. The discharge tube 20 is connected to a power supply 21 via the cathode 212 and the anode 214. The discharge tube 20 has an opening 216 defined at one end near the cathode 212 and a gas-returning tube 218 connected at other end near the anode 214, thus the discharge tube 20 is in communication with the gas chamber 23 via the opening 216 and the gas-returning tube 218. The cooler 22 is configured for cooling the discharge tube 20, the cooler 22 can be a water jacket or other coolant jacket. Preferably, a temperature controller cooperates with the cooler 22 for controlling the cooler 22. The gas chamber 23 contains a gas therein, the gas may be a mixture of carbon dioxide (CO2), nitrogen (N2), and helium (He). The mixed gas can flow into the discharge tube 20 via the opening 216, and be returned to the gas chamber 23 through the gas-returning tube 218. The nitrogen gas thereof can help to excite the carbon dioxide to produce laser light, and the helium gas thereof can assist the mixed gas heat transmission. The first mirror 24 is a totally reflecting mirror, and the second mirror 25 is partly transparent to laser light generated by the discharge tube 20.

The controller 11 is configured (i.e. structured and arranged) for controlling the operation of the laser 10, such as activation and deactivation of the power supply 21, adjustment of the power supply 21, and as well as control of processing parameters, such processing parameters may include pulse energy, pulse duration, and repetition rate. For example, in a process for welding glass workpieces, the pulse energy may be controlled in a range from 20 to 100 micro-joules, the pulse duration may be in a range from 20 to 200 microseconds, and the repetition rate may be in a range from 1000 to 10000 hertz (Hz).

The lens assembly 12 is a multiple lens assembly, which includes a collimating lens 121, and a converging lens 122. The collimating lens 121 is configured for collimating the laser beam from the laser 10 into a parallel and uniform laser beam, and the converging lens 122 is configured for converging the parallelized and uniformed laser beam to a focus point, thus forming a laser spot on a joint to be welded between the two workpieces 17. A size of the laser spot is preferably adjusted to match with a gap between the joint, for example, in a process of welding glass workpieces, a diameter of the laser spot may preferably be selected in the range from 10 to 100 micrometers.

The worktable 13 supports the cooling device 14 thereon, and the two workpieces 17 are positioned on the cooling device 14.

The worktable 13 is preferably seated on a movable stage movable in dimensions defined by the Cartesian co-ordinates X-Y-Z, or driven by a X direction motor, a Y direction motor, and a Z direction motor, thus a distance between surfaces of the two workpieces 17 and the focus point converged by the lens assembly 12 can be adjusted. The distance may influence a weld pool geometry shaped on the joint, and as well as weld penetration depth into the joint. When the focus point is situated above the upper surfaces of the two workpieces 17, it is called “positive defocus”, and when the focus point is situated below the upper surfaces of the two workpieces 17, it is called “negative defocus”. In practical use, in a process of welding thin-walled workpieces, it is practical to use the positive defocus, and in a process of welding thick-walled workpieces, or a deeper weld penetration is required, it is practical to use the negative defocus.

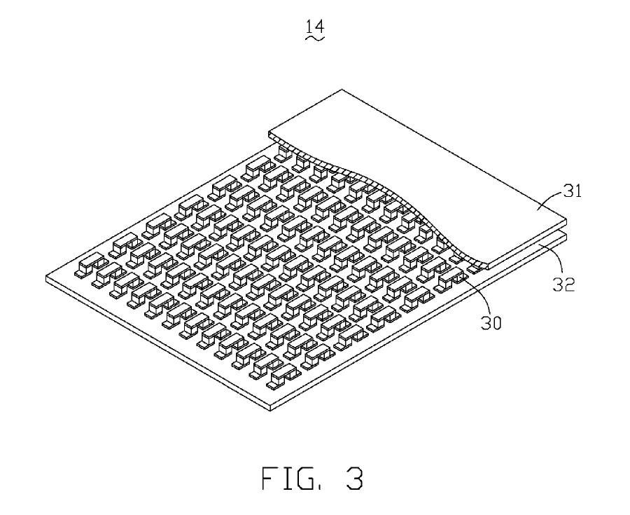

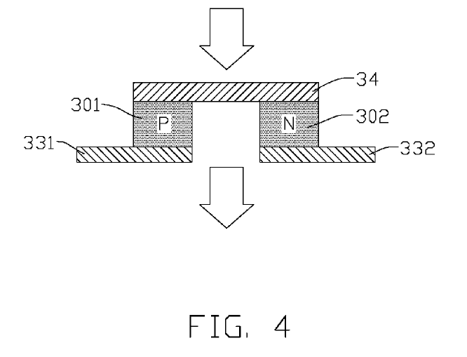

Referring to FIGS. 3 and 4, the cooling device 14 may be a thermal electric cooler. The thermal electric cooler includes a first substrate 31, a second substrate 32, and a number of cooling units 30 mounted therebetween. The first substrate 31 and the second substrate 32 are both electrically insulated, but have a good heat transfer capability. Both the first substrate 31 and the second substrate 32 can be made of ceramics. The cooling unit 30 includes a p-type semiconductor 301, an n-type semiconductor 302, a first electrode 331 connected to the p-type semiconductor 301, a second electrode 332 connected to the n-type semiconductor 302, and an electrical and thermal conductor 34 connected with both the p-type semiconductor 301 and the n-type semiconductor 302. The p-type semiconductor 301 and the n-type semiconductor 302 may both be an alloy of bismuth (Bi) and tellurium (Te). The first electrode 331 and the second electrode 332 are both disposed on the second substrate 32. The electrical and thermal conductor 34 is disposed opposite to the first electrode 331 and the second electrode 332, and is in thermal contact with the first substrate 31.

When the two workpieces 17 are placed on the first substrate 31, and a current is supplied from the second electrode 332 to the first electrode 331, the first substrate 31 becomes a cold side, and the second substrate 32 becomes a hot side. The first substrate 31 can absorb heat from the two workpieces 17 during the welding process, then the p-type semiconductor 301 and the n-type semiconductor 302 cooperate to conduct the heat to a second substrate 32, and the second substrate 32 discharges the heat to outside environment. Therefore, during the welding process, heat generated in the joint between the two workpieces 17 can be transferred away quickly, thus avoiding local overheating, and a bonding strength between the two workpieces 17 is improved, and an even welding surface is obtained.

Preferably, the laser apparatus may further include a detector 15 and a signal processing unit 16 (See FIG. 1). The detector 15 can be configured for detecting the weld pool geometry signals and the weld penetration depth signals, such signals may include audible signals, supersonic signals, ultraviolet radiation signals, visible light signals and infrared radiation signals produced by the two workpieces 17 and laser spot applied thereon during the welding process. The signal processing unit 16 receives and processes the signals from the detector 15, and feeds a feedback signal back to the controller 11 Thereby, the controller 11 can adjust the process parameters of the laser 10 quickly, thus enabling a better operational control of the laser 10.

It is understood that the laser apparatus is not limited to welding in application, and can be used for purposes including surface treatments such as etching, shaping, machining of one or more workpieces.

It is understood that the above-described embodiment are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A laser apparatus for treating a workpiece, comprising:
a worktable;
a cooling device disposed on the worktable configured for absorbing heat from the workpiece;
a laser configured for generating a laser beam; and
a lens assembly configured for converging the laser beam onto the workpiece.

2. The apparatus as claimed in claim 1, wherein the worktable is movable horizontally and vertically.

3. The apparatus as claimed in claim 1, wherein the cooling device is a thermal electric cooler.

4. The apparatus as claimed in claim 3, wherein the thermal electric cooler comprises a plurality of cooling units, the cooling units comprising a p-type semiconductor and an n-type semicoductor.

5. The apparatus as claimed in claim 3, wherein the thermal electric cooler comprises a cold side and a hot side, the workpiece positioned adjacent the cold side.

6. The apparatus as claimed in claim 1, wherein the laser is a gas laser.

7. The apparatus as claimed in claim 6, wherein the laser comprises a gas chamber having a first mirror at a first end of the gas chamber, and a second opposite mirror at an opposite second end thereof, a discharge tube received in the gas chamber and a power supply, opposite ends of the discharge tube being electrically connected to the power supply.

8. The apparatus as claimed in claim 7, further comprising a cooler disposed adjacent to the discharge tube and configured for cooling the discharge tube of the laser.

9. The apparatus as claimed in claim 1, wherein the laser beam has a pulse energy in the range from 20 micro-joules to 100 micro-joules, a pulse duration in the range from 20 microseconds to 200 microseconds, and a repetition rate in the range from 1000 hertz to 10000 hertz.

10. The apparatus as claimed in claim 1, wherein the lens assembly comprises a collimating lens and a converging lens.

11. The apparatus as claimed in claim 1, further comprising: a controller configured for controlling the laser, a detector configured for detecting signals produced from the workpiece, and a signal processing unit for receiving the signals from the detector and processing and feeding a corresponding feedback signal back to the controller.
